(19) United States
(12) Patent Application Publication
(10) Pub. No.: US 2024/0227880 A1
(43) Pub. Date: Jul. 11, 2024

(54) RAIL TRANSIT VEHICLE AUTOMATIC BATTERY SWAPPING CONTROL METHOD, DEVICE, VEHICLE, AND SYSTEM

(71) Applicant: BYD COMPANY LIMITED, SHENZHEN (CN)

(72) Inventors: Hao LU, Shenzhen (CN); Zhicheng TAN, Shenzhen (CN); Hongtao SHE, Shenzhen (CN); Mingyang GUO, Shenzhen (CN); Kangxian PAN, Shenzhen (CN)

(21) Appl. No.: 18/617,077

(22) Filed: Mar. 26, 2024

Related U.S. Application Data
(63) Continuation of application No. PCT/CN2022/125305, filed on Oct. 14, 2022.

(30) Foreign Application Priority Data
Oct. 14, 2021 (CN) 202111199799.8

(51) Int. Cl. B61K 11/00; B60L 53/80; B61L 15/00; B61L 27/70

(52) U.S. Cl. CPC B61K 11/00; B60L 53/80; B61L 15/0081; B61L 27/70; B60L 2200/26; B61L 2205/00

(57) ABSTRACT

A method of automatic battery swapping control for a rail transit vehicle is applicable to a rail transit vehicle automatic battery swapping system including a ground battery swapping device and a rail transit vehicle. The method includes: receiving a battery swapping signal, and in response to the battery swapping signal, blocking traction of the rail transit vehicle; communicating the in-vehicle wireless communication device with the ground wireless communication device, to enable battery swapping for the rail transit vehicle; receiving a battery swapping completion notification sent by the battery management system; and disconnecting the in-vehicle wireless communication device from the ground wireless communication device, and lifting the vehicle blockade of the rail transit vehicle.

### CROSS-REFERENCE TO RELATED APPLICATIONS

The application is a continuation application of International Patent Application No. PCT/CN2022/125305 filed on Oct. 14, 2022, which is based on and claims priority to and benefits of Chinese Patent Application No. 202111199799.8, filed on Oct. 14, 2021. The entire content of all of the above-referenced applications is incorporated herein by reference.

### FIELD

The present disclosure relates to the field of rail transit technologies, and more particularly, to a rail transit vehicle automatic battery swapping control method, a device, a vehicle, and a system.

### BACKGROUND

Rail transit is a type of transportation or a transportation system that requires an operated vehicle to travel on a specified track. Most typical rail transit is a railway system including a conventional train and a standard railway. With diversified development of train and railway technologies, rail transit has more and more types, which are not only used in long-distance transportation, but also widely used in short-and medium-distance urban public transportation. This type of rail transit vehicle running in urban public transportation is commonly referred to as “SkyShuttle”. An urban rail transit system is a large-capacity rapid public transportation system that uses electricity as a main power source and uses a wheel-rail operation system, and has a good development prospect due to energy saving and environmental protection. The urban rail transit system is mainly responsible for barrier-free and short-distance passenger transportation, and usually uses light electric multiple units or a tram as a transportation carrier, effectively relieving traffic pressure of dense passenger flows within a city.

Refer to FIG. 1. FIG. 1 is a schematic diagram of a conventional rail transit vehicle battery swapping control method. In the conventional battery swapping control method, a rail transit vehicle first includes a train control and management system (TCMS) and a battery management system (BMS). When the vehicle requires battery swapping, the TCMS sends a battery swapping request to the BMS, the BMS sends the battery swapping request to a battery swapping apparatus, and then a driver operates a control system of the vehicle to enable the vehicle to enter a ready state and receives a readiness signal sent by the vehicle. The BMS sends vehicle information to the battery swapping apparatus. After the battery swapping apparatus enters the ready state, an operator issues a battery swapping control command based on an intelligent control strategy recommended by a battery swapping monitoring system. After receiving the battery swapping control command, a battery swapping robot performs a battery swapping action until the battery swapping is completed.

In a conventional battery swapping system, the battery swapping is automatically performed by the battery swapping apparatus. During the battery swapping, manual selection of the vehicle information, battery information, and the like is required on site. This poses a specified safety risk in a case that there are many vehicles with batteries to be swapped or many batteries. For example, when the battery swapping is simultaneously performed for a multiple-unit vehicle or multiple carriages of a vehicle, it is prone to confuse the vehicle information or the battery information and cause a battery swapping error.

### SUMMARY

To resolve the foregoing problem, according to an aspect of the present disclosure, a method of automatic battery swapping control for a rail transit vehicle is provided, which is applied to a rail transit vehicle automatic battery swapping system. The rail transit vehicle automatic battery swapping system includes a ground battery swapping device and a rail transit vehicle. The ground battery swapping device includes a battery swapping server, at least one battery swapping apparatus, and at least one ground wireless communication device, the rail transit vehicle includes a train control and management system, at least one battery management system, and at least one in-vehicle wireless communication device, and the method includes:
receiving a battery swapping signal, and in response to the battery swapping signal, blocking traction of the rail transit vehicle;
communicating the in-vehicle wireless communication device with the ground wireless communication device, to enable battery swapping for the rail transit vehicle;
receiving a battery swapping completion notification sent by the battery management system; and
disconnecting the in-vehicle wireless communication device from the ground wireless communication device, and lifting a vehicle blockade of the rail transit vehicle.

In an embodiment of the present disclosure, after the controlling the in-vehicle wireless communication device to communicate with the ground wireless communication device, the method further includes:
sending a battery swapping request to the battery management system, to enable the battery management system to send the battery swapping request to the battery swapping server;
receiving a battery swapping acknowledge that is from the battery swapping server and is forwarded by the battery management system; and
receiving an in-progress battery swapping notification sent by the battery management system.

In an embodiment of the present disclosure, before the receiving a battery swapping completion notification sent by the battery management system, the method further includes:
receiving new battery information that is obtained after the battery swapping and is sent by the battery management system, where the new battery information includes at least one of: a battery type, a rated voltage, rated power, and a remaining available battery capacity of a battery pack.

In an embodiment of the present disclosure, the battery swapping signal includes a signal sent in response to a battery swapping knob of the rail transit vehicle is valid.

In an embodiment of the present disclosure, the ground wireless communication device and the in-vehicle wireless communication device are CAN-Wi-Fi converters, and the CAN-Wi-Fi converter is configured to implement conversion between a CAN signal and a Wi-Fi signal.

According to another aspect of the present disclosure, a method of automatic battery swapping control for a rail transit vehicle is provided, which is applied to a rail transit vehicle automatic battery swapping system. The rail transit vehicle automatic battery swapping system is configured to perform operations include:
receiving a battery swapping request sent by the train control and management system, and forwarding the battery swapping request to the battery swapping server, to enable battery swapping for the rail transit vehicle, where the battery swapping request is sent from the train control and management system to the battery management system after communicating the in-vehicle wireless communication device with the ground wireless communication device;
sending a battery swapping completion notification to the battery swapping server, and disconnecting the ground wireless communication device from the in-vehicle wireless communication device; and
sending the battery swapping completion notification to the train control and management system, to enable the in-vehicle wireless communication device to be disconnected from the ground wireless communication device, and lift a vehicle blockade of the rail transit vehicle.

In an embodiment of the present disclosure, after the receiving a battery swapping request sent by the train control and management system, and forwarding the battery swapping request to the battery swapping server, the method further includes:
sending battery information of a to-be-swapped battery to the battery swapping server, receiving battery information of a new battery sent by the battery swapping server, and determining whether the to-be-swapped battery matches the new battery;
forwarding the battery information of the new battery to the train control and management system.

In an embodiment of the present disclosure, after the receiving a battery swapping request sent by the train control and management system, and forwarding the battery swapping request to the battery swapping server, the method further includes:
sending a discharge disallowance signal to the train control and management system, and disconnecting discharge positive and negative pole contactors of the to-be-swapped battery.

In an embodiment of the present disclosure, after the sending a discharge disallowance signal to the train control and management system, and disconnecting discharge positive and negative pole contactors of the to-be-swapped battery, the method further includes:
sending an in-progress battery swapping notification to the train control and management system; and
receiving a battery swapping progress notification sent by the battery swapping server, and forwarding the battery swapping progress notification to the train control and management system.

In an embodiment of the present disclosure, the receiving a battery swapping request sent by the train control and management system, and forwarding the battery swapping request to the battery swapping server, to enable the battery swapping server to control the battery swapping apparatus to perform battery swapping for the rail transit vehicle includes:
receiving the battery swapping request sent by the train control and management system, and forwarding the battery swapping request to the battery swapping server;
receiving a battery swapping acknowledge from the battery swapping server, and forwarding the battery swapping acknowledge to the train control and management system;
receiving a handshake signal and an identification signal that are from the battery swapping server and performing a corresponding response to the handshake signal and the identification signal; and
sending a battery swapping readiness signal to the battery swapping server, to enable the battery swapping for the rail transit vehicle.

In an embodiment of the present disclosure, before the sending a battery swapping completion notification to the battery swapping server, the method further includes:
determining the new battery meets at least one of conditions including: a connector connection is valid, a water pipe connection is valid, and an installation buckle connection is valid.

In an embodiment of the present disclosure, after the sending the battery swapping completion notification to the train control and management system, the method further includes:
controlling a carriage in which the battery management system is located to be connected to a high-voltage power.

In an embodiment of the present disclosure, the ground wireless communication device and the in-vehicle wireless communication device include a CAN-Wi-Fi converter, and the CAN-Wi-Fi converter is configured to implement conversion between a CAN signal and a Wi-Fi signal.

According to another aspect of the present disclosure, a method of automatic battery swapping control for a rail transit vehicle is provided, which is applied to a rail transit vehicle automatic battery swapping system. The rail transit vehicle automatic battery swapping system includes a ground battery swapping device and a rail transit vehicle. The ground battery swapping device includes a battery swapping server, at least one battery swapping apparatus, and at least one ground wireless communication device, the rail transit vehicle includes a train control and management system, at least one battery management system, and at least one in-vehicle wireless communication device, and the method includes:
communicating the in-vehicle wireless communication device with the in-vehicle wireless communication device;
receiving a battery swapping request sent by the battery management system, and enabling, according to the battery swapping request, battery swapping for the rail transit vehicle;
receiving a battery swapping completion signal sent by the battery management system; and
sending a battery swapping completion notification to the battery management system in response to the battery swapping apparatus returns to the original location.

In an embodiment of the present disclosure, after the receiving a battery swapping request sent by the battery management system, the method further includes:
receiving battery information of a to-be-swapped battery sent by the battery management system; and
sending battery information of a new battery for the battery swapping to the battery management system, to determine that the new battery matches the to-be-swapped battery.

In an embodiment of the present disclosure, the controlling the battery swapping apparatus to perform battery swapping for the rail transit vehicle includes:
sending an in-progress battery swapping notification to the battery management system;
controlling the battery swapping apparatus to start a battery swapping action; and
monitoring battery swapping progress of the rail transit vehicle, and forwarding the battery swapping progress to the battery management system.

In an embodiment of the present disclosure, after the receiving a battery swapping request sent by the battery management system, the method further includes:
sending a battery swapping acknowledge to the battery management system; and
sending a handshake signal and an identification signal to the battery management system through the ground wireless communication device, and receiving a reply from the battery management system in response to the handshake signal and the identification signal.

In an embodiment of the present disclosure, after the receiving a battery swapping request sent by the battery management system, the method further includes:
receiving a battery swapping readiness signal sent by the battery management system; and
sending a battery swapping readiness signal to the battery management system.

In an embodiment of the present disclosure, the ground battery swapping device further includes a radio frequency reader, and the rail transit vehicle further includes a vehicle radio frequency tag; and
before the communicating the in-vehicle wireless communication device with the in-vehicle wireless communication device, the method further includes:
controlling the radio frequency reader to read information about the vehicle radio frequency tag, and storing the information about the vehicle radio frequency tag in a database of the battery swapping server, where the information about the vehicle radio frequency tag includes a vehicle number.

In an embodiment of the present disclosure, the ground wireless communication device and the in-vehicle wireless communication device include a CAN-Wi-Fi converter, and the CAN-Wi-Fi converter is configured to implement conversion between a CAN signal and a Wi-Fi signal.

According to another aspect of the present disclosure, a ground battery swapping device is provided. The ground battery swapping device includes a battery swapping server, at least one battery swapping apparatus, and at least one ground wireless communication device. The battery swapping server is configured to receive a battery swapping request sent by a battery management system, control the ground wireless communication device to communicate with an in-vehicle wireless communication device, control the battery swapping apparatus to perform battery swapping for a rail transit vehicle, detect, after receiving a battery swapping completion signal sent by the battery management system, whether the battery swapping apparatus returns to an original location, and send a battery swapping completion notification to the battery management system when the battery swapping apparatus returns to the original location;
the battery swapping apparatus is configured to perform a battery swapping; and
the ground wireless communication device is configured to be connected with the in-vehicle wireless communication device, to enable the battery swapping apparatus to perform the battery swapping for the rail transit vehicle.

According to another aspect of the present disclosure, a rail transit vehicle is provided. The rail transit vehicle includes a battery swapping knob, a train control and management system, at least one battery management system, and at least one in-vehicle wireless communication device.

The battery swapping knob is configured to send a battery swapping signal to the train control and management system when the battery swapping knob is rotated to be in a valid state.

The train control and management system is configured to receive the battery swapping signal, and control the rail transit vehicle to perform a vehicle blockade of a traction of the rail transit vehicle; control the in-vehicle wireless communication device to communicate with a ground wireless communication device, to enable a battery swapping apparatus to perform battery swapping for the rail transit vehicle; receive a battery swapping completion notification sent by the battery management system; and control the in-vehicle wireless communication device to be disconnected from the ground wireless communication device, and lift a vehicle blockade of the rail transit vehicle.

The battery management system is configured to receive a battery swapping request sent by the train control and management system, and forward the battery swapping request to a battery swapping server, to enable the battery swapping server to control the battery swapping apparatus to perform the battery swapping for the rail transit vehicle, where the battery swapping request is sent from the train control and management system to the battery management system after the in-vehicle wireless communication device communicates with the ground wireless communication device; send a battery swapping completion notification to the battery swapping server; and send the battery swapping completion notification to the train control and management system, to enable the train control and management system to control the in-vehicle wireless communication device to be disconnected from the ground wireless communication device, and lift a vehicle blockade of the rail transit vehicle.

The in-vehicle wireless communication device is configured to communicate with the ground wireless communication device, to enable the battery swapping apparatus to perform the battery swapping for the rail transit vehicle.

According to another aspect of the present disclosure, a rail transit vehicle automatic battery swapping system is provided. The rail transit vehicle automatic battery swapping system includes the foregoing ground battery swapping device and the rail transit vehicle.

### BRIEF DESCRIPTION OF THE DRAWINGS

Through a more detailed description of embodiments of the present disclosure in combination with accompanying drawings, the above and other objectives, features and advantages of the present disclosure are more obvious. The accompanying drawings are used to provide a further understanding of the embodiments of the present disclosure, constitute a part of this specification, and are used, together with the embodiments of the present disclosure, to explain the present disclosure, but do not constitute limitations to the present disclosure. In the accompanying drawings, same reference numerals generally represent same components or steps.

FIG. 1 is a schematic diagram of a rail transit vehicle battery swapping control method in a conventional technology;

FIG. 2 is a schematic flowchart of a rail transit vehicle automatic battery swapping control method according to an embodiment of the present disclosure;

FIG. 3 is a schematic flowchart of a rail transit vehicle automatic battery swapping control method according to an embodiment of the present disclosure;

FIG. 4 is a schematic flowchart of a rail transit vehicle automatic battery swapping control method according to an embodiment of the present disclosure;

FIG. 5 is a schematic block diagram of a ground battery swapping device according to an embodiment of the present disclosure;

FIG. 6 is a schematic block diagram of a rail transit vehicle according to an embodiment of the present disclosure; and

FIG. 7 is a schematic block diagram of a rail transit vehicle automatic battery swapping control system according to an embodiment of the present disclosure.

### DETAILED DESCRIPTION

To make the objectives, technical solutions, and advantages of the present disclosure more obvious, embodiments of the present disclosure are described in detail below with reference to the accompanying drawings. Apparently, the described embodiments are merely some but not all of the embodiments of the present disclosure. It should be understood that, the present disclosure is not limited by the embodiments described herein. All embodiments obtained by a person skilled in the art based on the embodiments of the present disclosure without creative efforts shall fall within the protection scope of the present disclosure.

Based on the foregoing technical problem, the present disclosure provides a rail transit vehicle automatic battery swapping control method, applied to a rail transit vehicle automatic battery swapping system. The rail transit vehicle automatic battery swapping system includes a ground battery swapping device and a rail transit vehicle. The ground battery swapping device includes a battery swapping server, at least one battery swapping apparatus, and at least one ground wireless communication device, the rail transit vehicle includes a train control and management system, at least one battery management system, and at least one in-vehicle wireless communication device, and the method includes: receiving a battery swapping signal, and in response to the battery swapping signal, controlling the rail transit vehicle to block traction of the entire vehicle, such as to perform a vehicle blockade of a traction of the rail transit vehicle; controlling the in-vehicle wireless communication device to be in a communication connection with the ground wireless communication device, to enable the battery swapping apparatus to perform battery swapping for the rail transit vehicle; receiving a battery swapping completion notification sent by the BMS; and controlling the in-vehicle wireless communication device to be disconnected from the ground wireless communication device, and lifting a vehicle blockade of the rail transit vehicle. During the battery swapping, because the vehicle and the ground battery swapping apparatus are interlocked, vehicle information can be quickly and automatically identified and matched, to implement real-time point-to-point communication between the vehicle and the ground battery swapping apparatus. In addition, in the technical solution of the present disclosure, when the vehicle and the battery swapping apparatus are physically connected, a safety hazard caused by a faulty connection part may be avoided, so that repair and maintenance costs are greatly reduced. In addition, in the rail transit vehicle automatic battery swapping control method, the apparatus, and the system in the present disclosure, battery swapping progress can be displayed and fed back in real time.

The solution of the rail transit vehicle automatic battery swapping control method according to the embodiments of the present disclosure is described in detail below with reference to the accompanying drawings. Features of the embodiments of the present disclosure may be mutually combined in a case that no conflict occurs.

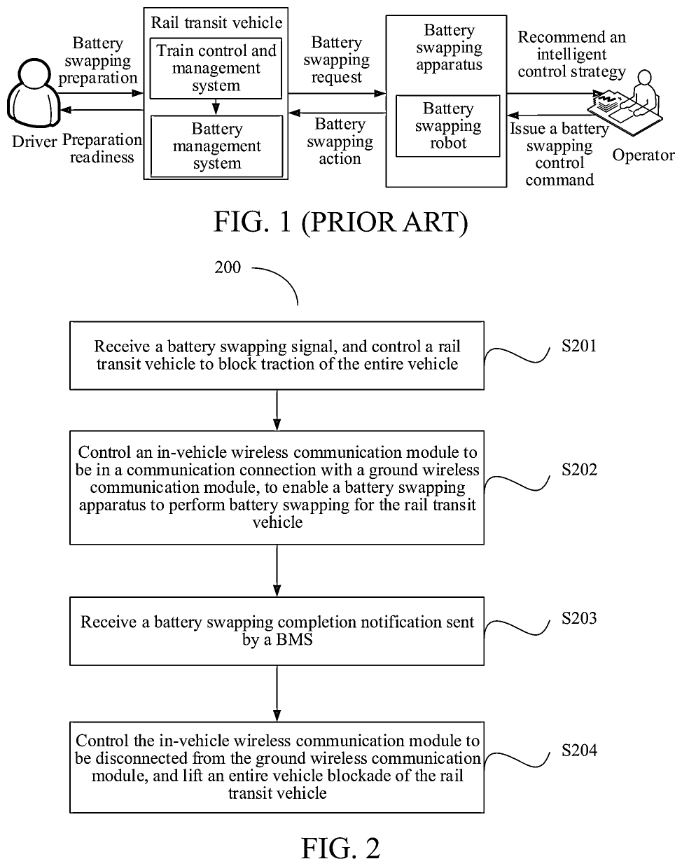

FIG. 2 is a schematic flowchart of a rail transit vehicle automatic battery swapping control method according to an embodiment of the present disclosure. As shown in FIG. 2, the rail transit vehicle automatic battery swapping control method in this embodiment of the present disclosure is applied to a rail transit vehicle automatic battery swapping system. The rail transit vehicle automatic battery swapping system includes a ground battery swapping device and a rail transit vehicle. The ground battery swapping device includes a battery swapping server, at least one battery swapping apparatus, and at least one ground wireless communication device. The rail transit vehicle includes a train control and management system, at least one battery management system, and at least one in-vehicle wireless communication device. A rail transit vehicle automatic battery swapping control method 200 according to this embodiment of the present disclosure may include the following steps: S201, S202, S203, and S204.

S201: A battery swapping signal is received, and the rail transit vehicle is controlled to block traction of the vehicle.

This embodiment is executed by the TCMS. A main function of the TCMS is to implement feature control, logic control, fault monitoring, and self-diagnosis that are of a locomotive, and transmit information to a microcomputer display screen on a console, so that a user can intuitively understand a real-time status of the locomotive.

A traction blockade is a protection function for a vehicle. When battery swapping is performed for the rail transit vehicle, braking the vehicle may cause battery swapping failure and even cause damage to some devices. To avoid this case, a protection function of a traction output blockade is set on the rail transit vehicle. During the battery swapping, blocking the traction of the vehicle may effectively prevent the battery swapping failure during the battery swapping of the vehicle and avoid causing damage to the device.

In an example, the battery swapping signal includes a signal sent when a battery swapping knob of the rail transit vehicle is valid. For example, when a battery needs to be swapped, the user may manually rotate the battery swapping knob to a valid location. When the battery swapping knob is in a valid state, the battery swapping signal is to be generated and sent to the TCMS.

In an example, the battery swapping knob may be arranged in cabs at two ends of the rail transit vehicle. When detecting that any battery swapping knob is valid, the TCMS may send a battery swapping request to the BMS.

S202: The in-vehicle wireless communication device is controlled to be in a communication connection with the ground wireless communication device, to enable the battery swapping apparatus to perform battery swapping for the rail transit vehicle.

The in-vehicle wireless communication device of the rail transit vehicle and the ground wireless communication device of the battery swapping apparatus are connected, to implement point-to-point wireless communication between the rail transit vehicle and the battery swapping apparatus. During the battery swapping, due to the point-to-point wireless communication between the rail transit vehicle and the battery swapping apparatus, and because the traction of the vehicle has been blocked, the vehicle cannot be braked. In this case, the vehicle and the battery swapping apparatus on a ground are interlocked, to avoid an error occurring during the battery swapping.

In some application scenarios, the rail transit vehicle may be driven to a preset battery swapping location, and then the traction of the vehicle is blocked, and the ground wireless communication device is lifted to the battery swapping location, to be in the communication connection with the in-vehicle wireless communication device. In some other application scenarios, the battery swapping apparatus and the ground wireless communication device may be kept still at the battery swapping location, and then the rail transit vehicle is lifted to enable the in-vehicle wireless communication device to be in the communication connection with the ground wireless communication device. The battery swapping can be implemented in all scenarios.

In an example, after the TCMS controls the in-vehicle wireless communication device to be in the communication connection with the ground wireless communication device, the method further includes the following steps. A1: A battery swapping request is sent to the BMS, to enable the BMS to send the battery swapping request to the battery swapping server. A2: A battery swapping acknowledge that is from the battery swapping server and is forwarded by the BMS is received. A3: An in-progress battery swapping notification sent by the BMS is received.

After the TCMS sends the battery swapping request to the BMS, if no response is received in a specified time interval, the TCMS continues to send the battery swapping request to the BMS, and when the battery swapping acknowledge that is from the battery swapping server and is forwarded by the BMS is received, the TCMS stops to send the battery swapping request to the BMS.

In an example, both the ground wireless communication device and the in-vehicle wireless communication device are CAN-Wi-Fi converters, and the CAN-Wi-Fi converter is configured to implement conversion between a CAN signal and a Wi-Fi signal. In this embodiment of the present disclosure, when the rail transit vehicle communicates with the battery swapping server, CAN data may be converted into Wi-Fi data through the in-vehicle wireless communication device, and the Wi-Fi data is sent to the ground wireless communication device. The ground wireless communication device converts the Wi-Fi data into the CAN data and sends the CAN data to the battery swapping server. Wireless communication between the rail transit vehicle and the battery swapping server may be implemented through the CAN-Wi-Fi converter, to avoid, when the vehicle and the battery swapping apparatus are physically connected, a safety hazard caused by a faulty connection part, so that repair and maintenance costs are greatly reduced.

S203: A battery swapping completion notification sent by the BMS is received.

During the battery swapping, the battery swapping server sends battery swapping progress to the BMS. When the battery progress is 100%, the BMS detects whether at least one of the states including a connector connection state, a water pipe connection state, and an installation buckle connection state of a new battery is valid, and feeds back whether the states are valid. If there is no problem, the battery swapping completion notification is sent to the server, to enable the server to send a control command of battery swapping completion and disconnection to the battery swapping apparatus. In addition, the BMS needs to send the battery swapping completion notification to the TCMS, and according to the battery swapping completion notification sent by the BMS, the TCMS may perform next action, for example, disconnecting the in-vehicle wireless communication device from the ground wireless communication device, and lifting a traction blockade of the vehicle.

A to-be-swapped battery and the new battery in this embodiment of the present disclosure may be battery packs.

In an example, before the battery swapping completion notification sent by the BMS is received, the method further includes: New battery information that is obtained after the battery swapping and is sent by the BMS is received. The new battery information includes at least one of the following: a battery type, a rated voltage, rated power, and a remaining available battery capacity that are of a battery pack. The rail transit vehicle does not necessarily support only one type of battery, but may support several types of batteries as long as it is ensured that a parameter satisfies a driving requirement of the vehicle. In this way, the vehicle may be more compatible. The new battery and the to-be-swapped battery are not necessarily exactly the same in terms of the parameter. Therefore, after the battery swapping is completed, the BMS needs to inform the TCMS of each parameter of the new battery.

S204: The in-vehicle wireless communication device is controlled to be disconnected from the ground wireless communication device, and a vehicle blockade of the rail transit vehicle is lifted.

After the battery swapping is completed, the vehicle blockade of the rail transit vehicle may be lifted, so that the rail transit vehicle may be braked and continuously operated. It is worth mentioning that the rail transit vehicle may be a multiple-unit vehicle. In this case, each carriage is provided with a battery, a BMS, and an in-vehicle wireless communication device. Correspondingly, the rail transit vehicle automatic battery swapping system is also provided with multiple battery swapping apparatuses and multiple ground wireless communication devices. The ground wireless communication devices are in a one-to-one correspondence with the battery swapping apparatuses. During the battery swapping, each in-vehicle wireless communication device is in a communication connection with a ground wireless communication device, to implement the battery swapping for the multiple-unit vehicle.

In this embodiment of the present disclosure, due to real time point-to-point communication between the vehicle and the ground battery swapping apparatus, and because the vehicle and the ground battery swapping apparatus are interlocked during the battery swapping, vehicle information can be quickly and automatically identified and matched, avoiding an error during the battery swapping. In addition, in the technical solution of the present disclosure, when the vehicle and the battery swapping apparatus are physically connected, a safety hazard caused by a faulty connection part may be avoided, so that repair and maintenance costs are greatly reduced.

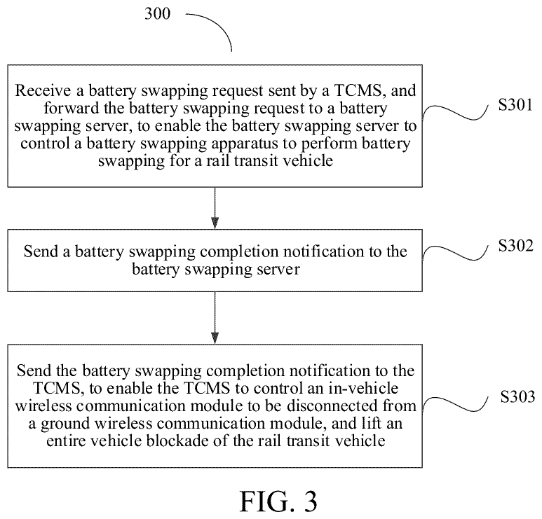

FIG. 3 is a schematic flowchart of a rail transit vehicle automatic battery swapping control method according to an embodiment of the present disclosure. As shown in FIG. 3, the rail transit vehicle automatic battery swapping control method in this embodiment of the present disclosure may be applied to a rail transit vehicle automatic battery swapping system. The rail transit vehicle automatic battery swapping system includes a ground battery swapping device and a rail transit vehicle. The ground battery swapping device includes a battery swapping server, at least one battery swapping apparatus, and at least one ground wireless communication device. The rail transit vehicle includes a train control and management system, at least one battery management system, and at least one in-vehicle wireless communication device. A rail transit vehicle automatic battery swapping control method 300 according to this embodiment of the present disclosure may include the following steps: S301, S302, and S303.

S301: A battery swapping request sent by the TCMS is received, and the battery swapping request is forwarded to the battery swapping server, to enable the battery swapping server to control the battery swapping apparatus to perform battery swapping for the rail transit vehicle. The battery swapping request is sent from the TCMS to the BMS after the in-vehicle wireless communication device is in a communication connection with the ground wireless communication device.

This embodiment of the present disclosure is executed by the BMS.

In an example, after the battery swapping request sent by the TCMS is received, and the battery swapping request is forwarded to the battery swapping server, the method further includes the following steps. B1: Battery information of a to-be-swapped battery is sent to the battery swapping server, and battery information that is of a new battery and is sent by the battery swapping server is received, to determine that the to-be-swapped battery matches the new battery. B2: The battery information of the new battery is forwarded to the TCMS. The rail transit vehicle does not necessarily support only one type of battery, but may support several types of batteries as long as it is ensured that a parameter satisfies a driving requirement of the vehicle. In this way, the vehicle may be more compatible. The new battery and the to-be-swapped battery are not necessarily exactly the same in terms of the parameter. Therefore, before the battery swapping, the BMS may send the battery information of the to-be-swapped battery to the battery swapping server for confirmation. In addition, the battery swapping server sends the battery information of the new battery to the BMS, to confirm whether the new battery can match the rail transit vehicle or not. If the new battery matches the rail transit vehicle, next action is performed. If the new battery does not match the rail transit vehicle, a prompt that the battery swapping cannot be performed may be sent to a user.

In an example of the present disclosure, after the battery swapping request sent by the TCMS is received, and the battery swapping request is forwarded to the battery swapping server, the method further includes: A discharge disallowance signal is sent to the TCMS, and discharge positive and negative pole contactors of the to-be-swapped battery are disconnected. During the battery swapping, because the battery is in an unavailable state, a load that requires power supply, for example, an air conditioner in the vehicle, needs to be disconnected.

In another example, after the discharge disallowance signal is sent to the TCMS, and the discharge positive and negative pole contactors of the to-be-swapped battery are disconnected, the method further includes the following steps. C1: An in-progress battery swapping notification is sent to the TCMS. C2: A battery swapping progress notification sent by the battery swapping server is received, and the battery swapping progress notification is forwarded to the TCMS. In this embodiment of the present disclosure, battery swapping progress can be displayed and fed back in real time, which enables the user to learn the battery swapping progress at any time, thereby improving user experience.

In an example, that a battery swapping request sent by the TCMS is received, and the battery swapping request is forwarded to the battery swapping server, to enable the battery swapping server to control the battery swapping apparatus to perform battery swapping for the rail transit vehicle includes the following steps. D1: The battery swapping request sent by the TCMS is received, and the battery swapping request is forwarded to the battery swapping server. D2: A battery swapping acknowledge from the battery swapping server is received, and the response is forwarded to the TCMS. D3: A handshake signal and an identification signal that are from the battery swapping server are received and a corresponding response is performed to the handshake signal and the identification signal. D4: A battery swapping readiness signal is sent to the battery swapping server, to enable the battery swapping server to control the battery swapping apparatus to perform the battery swapping for the rail transit vehicle.

In an example, both the ground wireless communication device and the in-vehicle wireless communication device are CAN-Wi-Fi converters, and the CAN-Wi-Fi converter is configured to implement conversion between a CAN signal and a Wi-Fi signal. In this embodiment of the present disclosure, when the rail transit vehicle communicates with the battery swapping server, CAN data may be converted into Wi-Fi data through the in-vehicle wireless communication device, and the Wi-Fi data is sent to the ground wireless communication device. The ground wireless communication device converts the Wi-Fi data into the CAN data and sends the CAN data to the battery swapping server. Wireless communication between the rail transit vehicle and the battery swapping server may be implemented through the CAN-Wi-Fi converter, to avoid, when the vehicle and the battery swapping apparatus are physically connected, a safety hazard caused by a faulty connection part, so that repair and maintenance costs are greatly reduced.

S302: A battery swapping completion notification is sent to the battery swapping server.

In an example, before the battery swapping completion notification is sent to the battery swapping server, the method further includes: That at least one of the following of the new battery is in a valid state is detected: a connector connection is valid, a water pipe connection is valid, and an installation buckle connection is valid. In an embodiment, when the foregoing information of the new battery is all in a valid state, it indicates that there is no abnormality in the new battery and the battery swapping is successful. In this case, the battery swapping completion notification may be sent to the battery swapping server by the BMS, to enable the battery swapping server to perform next action. If any one of the foregoing information of the new battery is not in a valid state, it indicates that there is an abnormality in the new battery, the battery swapping is unsuccessful, and the like. In this case, a prompt that the battery swapping is abnormal may be sent to the user.

S303: The battery swapping completion notification is sent to the train control and management system, to enable the train control and management system to control the in-vehicle wireless communication device to be disconnected from the ground wireless communication device, and lift a vehicle blockade of the rail transit vehicle.

In an example, after the battery swapping completion notification is sent to the TCMS, the method further includes: connecting a high-voltage power to a carriage in which the BMS is located is controlled. In this case, the new battery may be used for supplying power to the load in the vehicle, for example, supplying power to the air conditioner in the vehicle.

In this embodiment of the present disclosure, due to real time point-to-point communication between the vehicle and the ground battery swapping apparatus, and because the vehicle and the ground battery swapping apparatus are interlocked during the battery swapping, vehicle information can be quickly and automatically identified and matched, avoiding an error during the battery swapping. In addition, in the technical solution of the present disclosure, when the vehicle and the battery swapping apparatus are physically connected, a safety hazard caused by a faulty connection part may be avoided, so that repair and maintenance costs are greatly reduced.

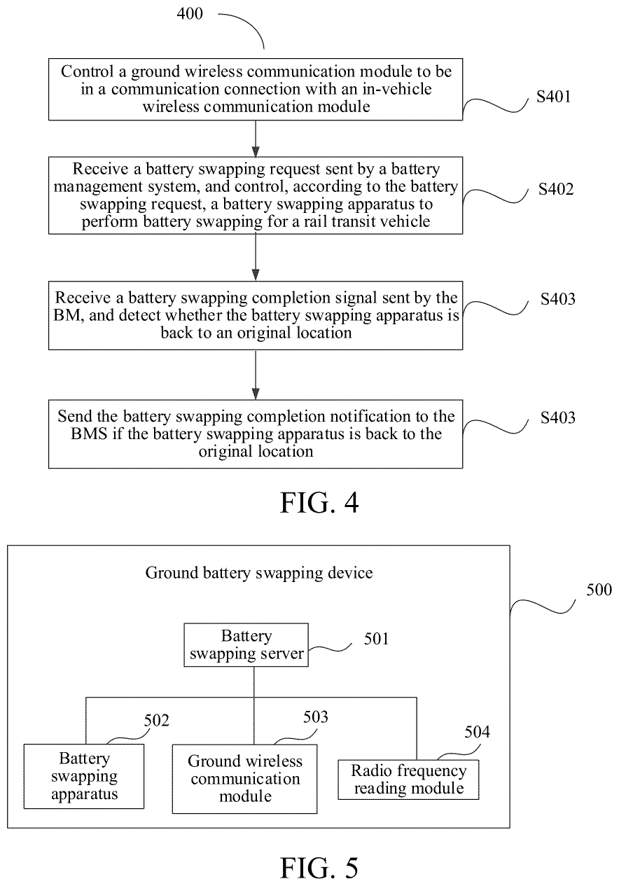

FIG. 4 is a schematic flowchart of a rail transit vehicle automatic battery swapping control method according to an embodiment of the present disclosure. As shown in FIG. 4, the rail transit vehicle automatic battery swapping control method in this embodiment of the present disclosure is applied to a rail transit vehicle automatic battery swapping system. The rail transit vehicle automatic battery swapping system includes a ground battery swapping device and a rail transit vehicle. The ground battery swapping device includes a battery swapping server, at least one battery swapping apparatus, and at least one ground wireless communication device. The rail transit vehicle includes a train control and management system, at least one battery management system, and at least one in-vehicle wireless communication device. A rail transit vehicle automatic battery swapping control method 400 according to this embodiment of the present disclosure may include the following steps: S401, S402, S403, and S404.

S401: The ground wireless communication device is controlled to be in a communication connection with the in-vehicle wireless communication device.

This embodiment of the present disclosure is executed by the battery swapping server. After the battery swapping server receives a battery swapping request, battery swapping is performed for the rail transit vehicle according to content of the battery swapping request.

In this embodiment of the present disclosure, due to real time point-to-point communication between the vehicle and the ground battery swapping apparatus, and because the vehicle and the ground battery swapping apparatus are interlocked during the battery swapping, vehicle information can be quickly and automatically identified and matched, avoiding an error during the battery swapping.

In an example, both the ground wireless communication device and the in-vehicle wireless communication device are CAN-Wi-Fi converters, and the CAN-Wi-Fi converter is configured to implement conversion between a CAN signal and a Wi-Fi signal. In this embodiment of the present disclosure, when the rail transit vehicle communicates with the battery swapping server, CAN data may be converted into Wi-Fi data through the in-vehicle wireless communication device, and the Wi-Fi data is sent to the ground wireless communication device. The ground wireless communication device converts the Wi-Fi data into the CAN data and sends the CAN data to the battery swapping server. Wireless communication between the rail transit vehicle and the battery swapping server may be implemented through the CAN-Wi-Fi converter, to avoid, when the vehicle and the battery swapping apparatus are physically connected, a safety hazard caused by a faulty connection part, so that repair and maintenance costs are greatly reduced.

In an example, the ground battery swapping device further includes a radio frequency reader, and the rail transit vehicle further includes a vehicle radio frequency tag. Before the ground wireless communication device is controlled to be in the communication connection with the in-vehicle wireless communication device, the method further includes: The radio frequency reader is controlled to read information about the vehicle radio frequency tag, and the information about the vehicle radio frequency tag is stored in a database of the battery swapping server. The information about the vehicle radio frequency tag includes a vehicle number. In this embodiment of the present disclosure, identity information of the vehicle is confirmed through a radio frequency identification technology. When the rail transit vehicle is a multiple-unit vehicle, the information about the vehicle radio frequency tag may further include number information of each carriage, to enable each charging apparatus to match each carriage, avoiding an error.

S402: A battery swapping request sent by the BMS is received, and according to the battery swapping request, the battery swapping apparatus is controlled to perform battery swapping for the rail transit vehicle.

In an example, before the battery swapping apparatus is controlled to perform the battery swapping for the rail transit vehicle, the method further includes the following steps. F1: Battery information that is of a to-be-swapped battery and is sent by the BMS is received. F2: Battery information of a new battery of the current battery swapping is sent to the BMS, to determine that the new battery matches the to-be-swapped battery. The rail transit vehicle does not necessarily support only one type of battery, but may support several types of batteries as long as it is ensured that a parameter satisfies a driving requirement of the vehicle. In this way, the vehicle may be more compatible. The new battery and the to-be-swapped battery are not necessarily exactly the same in terms of the parameter. Therefore, before the battery swapping, the BMS may send the battery information of the to-be-swapped battery to the battery swapping server for confirmation. In addition, the battery swapping server sends the battery information of the new battery to the BMS, to confirm whether the new battery can match the rail transit vehicle or not. If the new battery matches the rail transit vehicle, next action is performed. If the new battery does not match the rail transit vehicle, a prompt that the battery swapping cannot be performed may be sent to a user.

In an example, that the battery swapping apparatus is controlled to perform the battery swapping for the rail transit vehicle includes the following steps. F3: An in-progress battery swapping notification is sent to the BMS. F4: The battery swapping apparatus is controlled to start a battery swapping action. F5: Battery swapping progress of the rail transit vehicle is monitored, and the battery swapping progress is forwarded to the BMS. The BMS is enabled to forward the battery swapping progress to the TCMS, so that a user can learn the battery swapping progress in real time, thereby improving user experience.

In an example, after the battery swapping request sent by the BMS is received, the battery swapping server establishes a communication connection with the BMS, and a process is as below. The method further includes the following steps. E1: A battery swapping acknowledge is sent to the BMS. E2: A handshake signal and an identification signal are sent to the BMS through the ground wireless communication device, and a reply from the BMS in response to the handshake signal and the identification signal is received.

In an example, after the battery swapping request sent by the BMS is received, the method further includes the following steps. G1: A battery swapping readiness signal sent by the BMS is received. G2: A battery swapping readiness signal is sent to the BMS.

S403: A battery swapping completion signal sent by the BMS is received, and whether the battery swapping apparatus is back/returned to an original location is detected.

During the battery swapping, the rail transit vehicle may be driven to a preset battery swapping location, and then traction of the vehicle is blocked, and then the ground wireless communication device is moved to the battery swapping location by lifting, so that the ground wireless communication device is in the communication connection with the in-vehicle wireless communication device. In other application scenarios, the battery swapping apparatus and the ground wireless communication device may be kept still at the battery swapping location, and then the rail transit vehicle is lifted to enable the in-vehicle wireless communication device to be in the communication connection with the ground wireless communication device. The battery swapping can be implemented in all scenarios.

S404: A battery swapping completion notification is sent to the BMS if the battery swapping apparatus is back/returned to the original location.

If the battery swapping apparatus is back to the original location, it indicates that the battery swapping is successful. In this case, the battery swapping completion notification may be sent to the BMS, to enable the BMS to continue to perform next action.

In this embodiment of the present disclosure, due to real time point-to-point communication between the vehicle and the ground battery swapping apparatus, and because the vehicle and the ground battery swapping apparatus are interlocked during the battery swapping, vehicle information can be quickly and automatically identified and matched, avoiding an error during the battery swapping. In addition, in the technical solution of the present disclosure, when the vehicle and the battery swapping apparatus are physically connected, a safety hazard caused by a faulty connection part may be avoided, so that repair and maintenance costs are greatly reduced.

The ground battery swapping device in the present disclosure is described below with reference to FIG. 5. FIG. 5 is a schematic block diagram of a ground battery swapping device 500 according to an embodiment of the present disclosure.

The ground battery swapping device includes a battery swapping server 501, at least one battery swapping apparatus 502, at least one ground wireless communication device 503, and a radio frequency reader 504.

The battery swapping server 501 is configured to receive a battery swapping request sent by a BMS, control the ground wireless communication device 503 to be in a communication connection with an in-vehicle wireless communication device, control the battery swapping apparatus 502 to perform battery swapping for a rail transit vehicle, detect, after receiving a battery swapping completion signal sent by the BMS, whether the battery swapping apparatus 502 is back to an original location, and send a battery swapping completion notification to the BMS when the battery swapping apparatus 502 is back to the original location.

The battery swapping apparatus 502 is configured to perform a battery swapping action.

The ground wireless communication device 503 is configured to be connected with the in-vehicle wireless communication device, to perform the battery swapping for the rail transit vehicle.

The radio frequency reader 504 is configured to read information about a vehicle radio frequency tag 605, and send the read information to the battery swapping server.

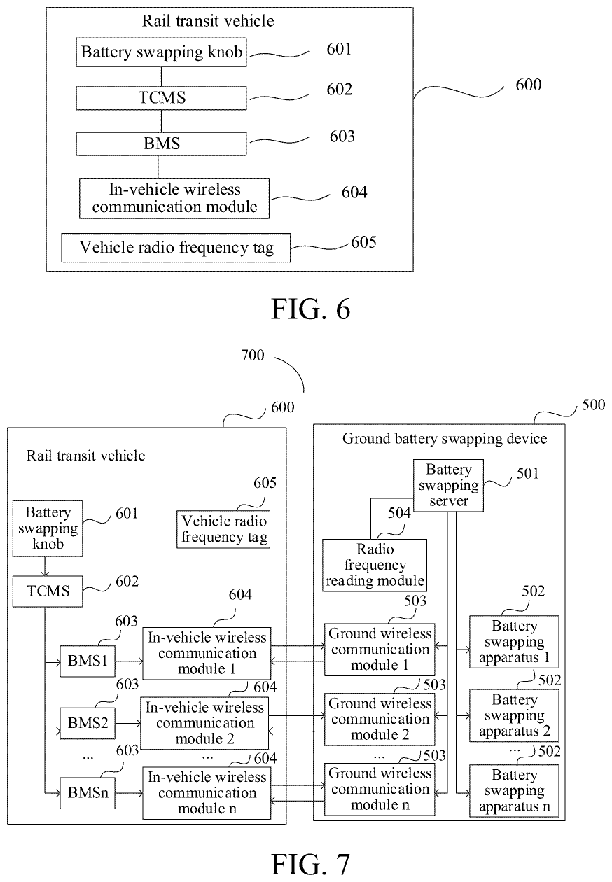

The rail transit vehicle in the present disclosure is described below with reference to FIG. 6. FIG. 6 is a schematic block diagram of a rail transit vehicle 600 according to an embodiment of the present disclosure.

The rail transit vehicle in this embodiment of the present disclosure includes a battery swapping knob 601, a TCMS 602, at least one BMS 603, at least one in-vehicle wireless communication device 604, and a vehicle radio frequency tag 605.

The battery swapping knob 601 is configured to send a battery swapping signal to the TCMS 602 when the battery swapping knob 601 is rotated to be in a valid state.

The TCMS 602 is configured to receive the battery swapping signal, and control the rail transit vehicle 600 to block traction of the vehicle; control the in-vehicle wireless communication device 604 to be in a communication connection with a ground wireless communication device, to enable a battery swapping apparatus to perform battery swapping for the rail transit vehicle 600; receive a battery swapping completion notification sent by the BMS 603; and control the in-vehicle wireless communication device 604 to be disconnected from the ground wireless communication device, and lift a vehicle blockade of the rail transit vehicle 600.

The BMS 603 is configured to receive a battery swapping request sent by the TCMS 602, and forward the battery swapping request to the battery swapping server, to enable the battery swapping server to control the battery swapping apparatus to perform battery swapping for the rail transit vehicle. The battery swapping request is sent from the TCMS 602 to the BMS 603 after the in-vehicle wireless communication device 604 is in the communication connection with the ground wireless communication device; send a battery swapping completion notification to the battery swapping server; and send the battery swapping completion notification to the TCMS 602, to enable the TCMS 602 to control the in-vehicle wireless communication device 604 to be disconnected from the ground wireless communication device, and lift a vehicle blockade of the rail transit vehicle.

The in-vehicle wireless communication device 604 is configured to be in the communication connection with the ground wireless communication device, to enable the battery swapping apparatus to perform the battery swapping for the rail transit vehicle.

The vehicle radio frequency tag 605 is configured to generate a radio frequency signal, and vehicle information may be obtained when a radio frequency reader 504 reads the radio frequency signal.

The rail transit vehicle automatic battery swapping system in the present disclosure is described below with reference to FIG. 7. FIG. 7 is a schematic block diagram of a rail transit vehicle automatic battery swapping system 700 according to an embodiment of the present disclosure.

The rail transit vehicle automatic battery swapping system 700 in this embodiment of the present disclosure includes a rail transit vehicle 600 and a ground battery swapping device 500. The rail transit vehicle 600 includes a battery swapping knob 601, a TCMS 602, at least one BMS 603, at least one in-vehicle wireless communication device 604, and a vehicle radio frequency tag 605. The rail transit vehicle may be a multiple-unit vehicle. In other words, multiple carriages are included. Each carriage includes a BMS 603, a battery, and an in-vehicle wireless communication device 604.

Correspondingly, the ground battery swapping device 500 includes a battery swapping server 501, at least one battery swapping apparatus 502, at least one ground wireless communication device 503, and a radio frequency reader 504. When the rail transit vehicle is a multiple-unit vehicle, the ground battery swapping device 500 may correspondingly include multiple ground wireless communication devices 503 and multiple battery swapping apparatuses 502. In addition, one ground wireless communication device corresponds to one battery swapping apparatus.

During battery swapping, the radio frequency reader 504 reads information about the vehicle radio frequency tag 605, and sends the information to the battery swapping server 501. The battery swapping server 501 stores the information in a local database. Then the battery swapping server 501 controls the in-vehicle wireless communication device 604 to be connected with the ground wireless communication device 503. As shown in FIG. 7, each in-vehicle wireless communication device 604 is in a wireless communication with one ground wireless communication device 503. To be specific, an in-vehicle wireless communication device 1 is connected with a ground wireless communication device 1, an in-vehicle wireless communication device 2 is connected with a ground wireless communication device 2 . . . , and an in-vehicle wireless communication device n is connected with a ground wireless communication device n. When each in-vehicle wireless communication device 604 is connected with the ground wireless communication device 503, each battery is enabled to match each battery swapping apparatus 502, to avoid an error occurring in the battery swapping.

The ground battery swapping device, a rail transit vehicle automatic battery swapping apparatus, and the rail transit vehicle automatic battery swapping system in this embodiment of the present disclosure can implement the foregoing battery swapping method, and therefore have the same advantages as the foregoing battery swapping method.

Although embodiments have been described with reference to accompanying drawings, it should be understood that the above embodiments are only illustrative, and not to limit the scope of the present disclosure thereto. Various changes and modifications can be made by a person of ordinary skill in the art without departing from the scope and spirit of the present disclosure. All these changes and modifications are to be embraced in the scope of the present disclosure as defined in the appended claims.

A person of ordinary skill in the art may be aware that, the units and algorithm steps described with reference to the embodiments disclosed in this specification can be implemented by using electronic hardware or a combination of computer software and electronic hardware. Whether the functions are executed in a mode of hardware or software depends on particular applications and design constraint conditions of the technical solutions. A person skilled in the art may use different methods to implement the described functions for each particular application, but it should not be considered that the implementation goes beyond the scope of the present disclosure.

In the several embodiments provided in the present disclosure, it should be understood that the disclosed device and method may be implemented in other manners. For example, the described device embodiments are merely examples. For example, the unit division is merely logical function division and may be other division during actual implementation. For example, multiple units or components may be combined or integrated into another device, or some features may be ignored or not performed.

Numerous details are set forth in the specification provided herein. However, it should be understood that the embodiments of the present disclosure may be practiced without the details. In some examples, known methods, structures, and technologies are not shown in detail so as not to obscure understanding on the specification.

Similarly, it should be understood that to simplify the present disclosure and help to understand one or more of disclosure aspects, in the descriptions of the embodiments of the present disclosure, features of the present disclosure are sometimes grouped into a single embodiment or figure, or descriptions thereof. However, the methods in the present disclosure should not be construed as reflecting the following intention: that is, the present disclosure claimed to be protected is required to have more features than those clearly set forth in each claim. More definitely, as reflected in the corresponding claims, the inventiveness of the disclosure lies in resolving the corresponding technical problem using features less than all features of a single embodiment disclosed above. Therefore, the claims complying with an implementation are hereby explicitly incorporated into the implementation, where each claim is a separate embodiment of the present disclosure.

A person skilled in the art may understand that, all features disclosed in this specification (including the accompanying claims, abstract and drawings), and all processes or units of any method or device disclosed herein may be combined in any combination, unless features are mutually exclusive. Unless otherwise expressly stated, each of the feature disclosed in this specification (including the appended claims, abstract, and accompanying drawings) may be replaced with a feature that achieves the same, equivalent or similar purpose.

In addition, a person skilled in the art can understand that, although some embodiments herein include some but not other features included in some embodiments, combinations of features of different embodiments are meant to be within the scope of the present disclosure and to form different embodiments. For example, in the claims, any one of the claimed embodiments may be used in any combination.

The various component embodiments of the present disclosure may be implemented in hardware or in software modules running on one or more processors or in a combination thereof. A person skilled in the art should understand that a microprocessor or a digital signal processor (DSP) may be used in practice to implement some or all of the functions of some modules according to the embodiments of the present disclosure. The present disclosure may be implemented as an apparatus program (for example, a computer program and a computer program product) for performing part or all of the methods described herein. Such a program that implements the present disclosure may be stored on a computer-readable medium or may be in the form of one or more signals. Such signals may be downloaded from Internet websites, provided on carrier signals, or provided in any other form.

It should be noted that the foregoing embodiments illustrate rather than limit the present disclosure, and those skilled in the art may devise embodiments without departing from the scope of the appended claims. In the claims, any reference sign between parentheses shall not be construed as limiting the claims. The word “include” does not exclude the presence of elements or steps not listed in the claims. The word “a” or “an” preceding an element does not exclude the presence of a number of such elements. The present disclosure may be implemented by means of hardware including different elements and a suitably programmed computer. In the unit claims enumerating several apparatuses, several of these apparatuses can be embodied by the same item of hardware. The use of the words such as “first”, “second”, “third”, and the like does not denote any order. These words can be interpreted as names.

The foregoing description is merely an implementation of the present disclosure or description of an implementation, and the protection scope of the present disclosure is not limited thereto. Any variation or replacement readily figured out by a person skilled in the art within the technical scope disclosed in the present disclosure shall fall within the protection scope of the present disclosure. The protection scope of the present disclosure shall be subject to the protection scope of the claims.

### REFERENCE NUMERALS

500: ground battery swapping device;
501: battery swapping server;
502: battery swapping apparatus;
503: ground wireless communication device;
504: radio frequency reader;
600: rail transit vehicle;
601: battery swapping knob;
602: TCMS;
603: BMS;
604: in-vehicle wireless communication device; and
605: vehicle radio frequency tag.

What is claimed is:

1. A method of automatic battery swapping control for a rail transit vehicle, applied to a rail transit vehicle automatic battery swapping system, the rail transit vehicle automatic battery swapping system comprising a ground battery swapping device and the rail transit vehicle, wherein
the ground battery swapping device comprises a battery swapping server, at least one battery swapping apparatus, and at least one ground wireless communication device,
the rail transit vehicle comprises a train control and management system, at least one battery management system, and at least one in-vehicle wireless communication device, and
the method comprises:
receiving a battery swapping signal, and in response to the battery swapping signal, blocking traction of the rail transit vehicle;
communicating the in-vehicle wireless communication device with the ground wireless communication device, to enable battery swapping for the rail transit vehicle;
receiving a battery swapping completion notification sent by the battery management system; and
disconnecting the in-vehicle wireless communication device from the ground wireless communication device, and lifting the blocking of traction of the rail transit vehicle.

2. The method according to claim 1, after the communicating the in-vehicle wireless communication device with the ground wireless communication device, the method further comprising:
sending a battery swapping request to the battery management system, to enable the battery management system to send the battery swapping request to the battery swapping server;
receiving a battery swapping acknowledge that is from the battery swapping server and is forwarded by the battery management system; and
receiving an in-progress battery swapping notification sent by the battery management system.

3. The method according to claim 1, before the receiving a battery swapping completion notification sent by the battery management system, the method further comprising:
receiving new battery information that is obtained after the battery swapping and is sent by the battery management system, wherein the new battery information comprises at least one of: a battery type, a rated voltage, rated power, and a remaining available battery capacity of a battery pack.

4. The method according to claim 1, wherein the battery swapping signal comprises a signal sent in response to a battery swapping knob of the rail transit vehicle is valid.

5. The method according to claim 1, wherein the ground wireless communication device and the in-vehicle wireless communication device are CAN-Wi-Fi converters, and the CAN-Wi-Fi converter is configured to implement conversion between a CAN signal and a Wi-Fi signal.

6. A method of automatic battery swapping control for a rail transit vehicle, applied to a rail transit vehicle automatic battery swapping system, the rail transit vehicle automatic battery swapping system is configured to perform operations comprising:
receiving a battery swapping request sent by a train control and management system, and forwarding the battery swapping request to the battery swapping server, to enable battery swapping for the rail transit vehicle, wherein the battery swapping request is sent from the train control and management system to a battery management system after communicating an in-vehicle wireless communication device with a ground wireless communication device;
sending a battery swapping completion notification to the battery swapping server, and disconnecting the ground wireless communication device from the in-vehicle wireless communication device; and
sending the battery swapping completion notification to the train control and management system, to enable the in-vehicle wireless communication device to be disconnected from the ground wireless communication device, and lift a vehicle blockade of the rail transit vehicle.

7. The method according to claim 6, after the receiving a battery swapping request sent by the train control and management system and forwarding the battery swapping request to the battery swapping server, the method further comprising:
sending battery information of a to-be-swapped battery to the battery swapping server, receiving battery information of a new battery sent by the battery swapping server, and determining whether the to-be-swapped battery matches the new battery; and
forwarding the battery information of the new battery to the train control and management system.

8. The method according to claim 7, after the receiving a battery swapping request sent by the train control and management system and forwarding the battery swapping request to the battery swapping server, the method further comprising:
sending a discharge disallowance signal to the train control and management system, and disconnecting discharge positive and negative pole contactors of the to-be-swapped battery.

9. The method according to claim 8, after the sending a discharge disallowance signal to the train control and management system and disconnecting discharge positive and negative pole contactors of the to-be-swapped battery, the method further comprising:
sending an in-progress battery swapping notification to the train control and management system; and
receiving a battery swapping progress notification sent by the battery swapping server, and forwarding the battery swapping progress notification to the train control and management system.

10. The method according to claim 6, wherein the receiving the battery swapping request sent by the train control and management system, and forwarding the battery swapping request to the battery swapping server, to enable the battery swapping server to control the battery swapping apparatus to perform battery swapping for the rail transit vehicle comprises:
receiving the battery swapping request sent by the train control and management system, and forwarding the battery swapping request to the battery swapping server;
receiving a battery swapping acknowledge from the battery swapping server, and forwarding the battery swapping acknowledge to the train control and management system;
receiving a handshake signal and an identification signal from the battery swapping server, and performing a corresponding response to the handshake signal and the identification signal; and
sending a battery swapping readiness signal to the battery swapping server, to enable the battery swapping for the rail transit vehicle.

11. The method according to claim 7, before the sending a battery swapping completion notification to the battery swapping server, the method further comprising:
determining the new battery meets at least one of conditions including: a connector connection is valid, a water pipe connection is valid, and an installation buckle connection is valid.

12. The method according to claim 6, after the sending the battery swapping completion notification to the train control and management system, the method further comprising:
controlling a carriage in which the battery management system is located to be connected to a high-voltage power.

13. The method according to claim 6, wherein the ground wireless communication device and the in-vehicle wireless communication device comprise a CAN-Wi-Fi converter, and the CAN-Wi-Fi converter is configured to implement conversion between a CAN signal and a Wi-Fi signal.

14. A method of automatic battery swapping control for a rail transit vehicle, applied to a rail transit vehicle automatic battery swapping system, the rail transit vehicle automatic battery swapping system comprising a ground battery swapping device and the rail transit vehicle, wherein
the ground battery swapping device comprises a battery swapping server, at least one battery swapping apparatus, and at least one ground wireless communication device,
the rail transit vehicle comprises a train control and management system, at least one battery management system, and at least one in-vehicle wireless communication device, and
the method comprises:
communicating the in-vehicle wireless communication device with the in-vehicle wireless communication device;
receiving a battery swapping request sent by the battery management system, and enabling, according to the battery swapping request, battery swapping for the rail transit vehicle;
receiving a battery swapping completion signal sent by the battery management system; and
sending a battery swapping completion notification to the battery management system in response to the battery swapping apparatus returns to an original location.

15. The method according to claim 14, after the receiving the battery swapping request sent by the battery management system, the method further comprising:
receiving battery information of a to-be-swapped battery sent by the battery management system; and
sending battery information of a new battery for the battery swapping to the battery management system, to determine that the new battery matches the to-be-swapped battery.

16. The method according to claim 14, wherein the enabling the battery swapping apparatus to perform battery swapping for the rail transit vehicle comprises:
sending an in-progress battery swapping notification to the battery management system;
controlling the battery swapping apparatus to start the battery swapping; and
monitoring battery swapping progress of the rail transit vehicle, and forwarding the battery swapping progress to the battery management system.

17. The method according to claim 14, after the receiving the battery swapping request sent by the battery management system, the method further comprising:
sending a battery swapping acknowledge to the battery management system; and
sending a handshake signal and an identification signal to the battery management system through the ground wireless communication device, and receiving a reply from the battery management system in response to the handshake signal and the identification signal.

18. The method according to claim 14, after the receiving the battery swapping request sent by the battery management system, the method further comprising:
receiving a battery swapping readiness signal sent by the battery management system; and
sending the battery swapping readiness signal to the battery management system.

19. The method according to claim 14, wherein
the ground battery swapping device further comprises a radio frequency reader, and the rail transit vehicle further comprises a vehicle radio frequency tag; and
before the communicating the in-vehicle wireless communication device with the in-vehicle wireless communication device, the method further comprises:
controlling the radio frequency reader to read information about the vehicle radio frequency tag, and storing the information about the vehicle radio frequency tag in a database of the battery swapping server, wherein the information about the vehicle radio frequency tag comprises a vehicle number.

20. The method according to claim 14, wherein the ground wireless communication device and the in-vehicle wireless communication device comprise a CAN-Wi-Fi converter, and the CAN-Wi-Fi converter is configured to implement conversion between a CAN signal and a Wi-Fi signal.
